(19) United States
(12) Patent Application Publication
(10) Pub. No.: US 2026/0167141 A1
(43) Pub. Date: Jun. 18, 2026

(54) AUTONOMOUS VEHICLE INTERIOR WITH CUSTOMIZABLE PRIVACY PODS

(71) Applicant: Joseph Joseph Oruvanchiyel, Des Plaines, IL (US)

(72) Inventor: Joseph Joseph Oruvanchiyel, Des Plaines, IL (US)

(21) Appl. No.: 19/415,969

(22) Filed: Dec. 11, 2025

Related U.S. Application Data
(60) Provisional application No. 63/733,493, filed on Dec. 13, 2024.

(51) Int. Cl. B60R 21/02; B60J 1/20; B60R 7/08

(52) U.S. Cl. CPC B60R 21/026; B60J 1/2011; B60R 7/08

(57) ABSTRACT

An autonomous vehicle interior assembly is disclosed. The interior assembly is a modular system installable within an autonomous vehicle and includes a floor, a longitudinal partition, and multiple transverse partitions defining a plurality of individual passenger privacy pods. Each pod includes a reclining passenger seat, a control screen, a retractable tray, individually controllable lighting and ventilation assemblies, and a dedicated luggage compartment positioned outside the pod. The longitudinal partition includes movable opaque privacy windows selectively openable to enable communication between adjacent pods. The interior assembly is configured for installation in autonomous vehicles operable in one or both travel directions while maintaining a fixed interior orientation and consistent passenger privacy.

### CROSS-REFERENCE TO RELATED APPLICATIONS

This application claims the benefit of U.S. Provisional Patent Application Ser. No. 63/733,493, filed on Dec. 13, 2024, which is incorporated by reference herein in its entirety.

### FIELD OF THE INVENTION

The present invention relates generally to vehicle interiors, and more particularly, to a modular vehicle interior for use in various styles of autonomous vehicles, which may be a uni-directional or bi-directional.

### BACKGROUND OF THE INVENTION

Many types of vehicles are used to transport people. Taxis and/or private vehicle services such as, for example Uber and Lyft, are utilized by many people to get from place to place. Such vehicle services require the presence of a driver. Quite often, the driver wishes to converse with the passengers. While this may be enjoyable and even informative, many times the passenger simply wants some quiet time and does not wish to engage with the driver. In such circumstances, there is little the passenger can do avoid the situation and maintain some semblance of peace.

The situation can be exacerbated when the taxis or other private vehicle services carry more than one passenger. For example, a single taxis may pick up several unrelated passengers. Unfortunately for the passenger desiring peace and quiet, the other passenger may wish to engage in conversation. From this there is no escape.

Recently, autonomous vehicles or self-operating vehicles have come on the market and may be used for public transportation. The autonomous vehicles do away with the need for a driver and operate according to a computer program or are remotely controlled. When these vehicles are used as taxis or the like, the issue of having to deal with a talkative driver is eliminated. However, the problem of dealing with other potential passengers still exists.

Furthermore, in either the driver operated vehicle or in the autonomous vehicles, the environmental conditions are typically unitary, that is, there is usually only one heating, ventilation and air conditioning system. What is comfortable for one passenger may be uncomfortable to another passenger leading to unpleasant disagreements.

Accordingly, there is need for a solution to at least one of the aforementioned problems. For instance, there is an established need for a vehicle transport system or module that eliminates the need to engage with a driver. There is a still further established need for a vehicle transport system or module that eliminates the need to engage with fellow passengers.

### SUMMARY OF THE INVENTION

According to an implementation of the present disclosure, there is provided a modular interior assembly configured for installation from modular components within an autonomous vehicle. The interior assembly comprises a floor and a set of partitions including a longitudinal or first partition extending in a front-to-rear direction of the vehicle, a middle horizontal or second partition transverse to the first partition, a front horizontal or third partition transverse to the first partition, and a rear horizontal or fourth partition transverse to the first partition. The first, second, third, and fourth partitions may be supported by the floor, the roof, or any suitable structural support elements within the vehicle body. The partitions together define multiple individual passenger privacy pods, each configured to receive a passenger in complete privacy and isolation from adjacent pods. The interior assembly may further include at least one privacy window positioned in the first partition, the privacy window comprising a window opening and an opaque window pane movable between an open position enabling communication between adjacent pods and a closed position maintaining privacy, and a plurality of passenger seats disposed within corresponding pods and secured to the floor. A roof structure may also be included above the partitions to complete vertical separation of the pods.

In an aspect, the longitudinal or first partition and the middle, front, and rear horizontal partitions, together with the floor, may optionally be manufactured as an integral or partially integrated assembly to facilitate installation or transfer between autonomous vehicles. In other aspects, the first, second, third, and fourth partitions may be separately formed as modular components and supported by the floor, the roof, or other suitable structural support elements within the vehicle body for installation within the autonomous vehicle. In an aspect, the first, second, third, and fourth partitions and the floor may optionally be manufactured as an integral or partially integrated assembly to facilitate installation or transfer between autonomous vehicles. In other aspects, the partitions may be separately formed components assembled within the vehicle.

In an aspect, the first, second, third, and fourth partitions may be separately formed and fixedly secured to the vehicle floor, roof, or structural members during installation within the autonomous vehicle.

In an aspect, the first partition may be formed as either a single continuous structure or as two separate sections, including a front section and a rear section. A front privacy window may be provided in the front section, and a rear privacy window may be provided in the rear section.

In an aspect, the opaque window pane may be selectively movable by an electric motor and controllable from either of two adjacent passenger privacy pods through a control screen, physical switch, touch interface, gesture recognition system, voice control, or any other suitable user-operated input device.

In an aspect, the opaque window pane may be locked in the closed position when adjacent passenger privacy pods are occupied by non-associated passengers, and may be enabled for opening only when both pods are assigned to the same party, family, or group of related passengers. When enabled, the passengers may selectively lower the window through a control screen, mobile application, physical switch, or other suitable user interface.

In an aspect, each of the passenger privacy pods may comprise a corresponding retractable tray movable between a deployed condition and a stored condition. The retractable tray may be stored within a partition or within the armrest of the passenger seat, and may be supported by a pivotal bracket or any suitable deployment mechanism operatively associated with the partition or the seat armrest.

In an aspect, the interior assembly may further comprise individualized lighting assemblies and ventilation assemblies, each located and operable within a corresponding passenger privacy pod.

In an aspect, each lighting assembly and ventilation assembly may be positioned at any suitable location within the corresponding passenger privacy pod. Each assembly may be individually controllable by the passenger through a control screen, physical switch, gesture interface, mobile application, or any other suitable control mechanism.

In an aspect, the interior assembly may further comprise an individualized luggage or storage compartment assigned to each passenger privacy pod, wherein each luggage compartment is positioned outside the corresponding pod and accessible only by the passenger assigned to that pod.

In an aspect, each luggage compartment may comprise a compartment door that may be lockable and unlockable by a mechanical or electronic key, mobile application, vehicle-access interface, physical switch, biometric identifier, or any other suitable user-operated control mechanism associated with the corresponding passenger privacy pod.

In an aspect, each passenger seat may be a reclining type seat having movable adjustments in a recline direction, an up/down direction, and a forward/back direction, and includes a movable thigh support.

In an aspect, each control screen may provide entertainment video, internet access, and the ability to control one or more pod functions, including a privacy window, a lighting assembly, a ventilation assembly, or a reclining seat. These functions may additionally or alternatively be controllable through a touch-screen interface, touchpad, gesture-based interface, remote control device, mobile application, physical switch, or any other suitable user interface.

In an aspect, the control screen may further enables passengers to enter destinations of travel and perform payment for transportation provided by the autonomous vehicle.

In an aspect, the interior assembly may be installable as a modular unit in multiple vehicle types, comprising a mini-van style autonomous vehicle and a multi-purpose autonomous vehicle.

In an aspect, the interior assembly may be configurable as a two-person version that comprises the first partition, the second partition, and the third partition defining a left-side passenger privacy pod and a right-side passenger privacy pod.

In an aspect, the autonomous vehicle in which the interior assembly is installed may be configured for uni-directional and bi-directional travel, wherein the autonomous vehicle is operable in either travel direction with interchangeable front and rear sides, and wherein the autonomous vehicle is further configured to facilitate curbside boarding, egress, and emergency exit from any passenger privacy pod.

In an aspect, the interior assembly may be generally symmetrical about a longitudinal centerline of the vehicle body, such that the passenger privacy pods can be comfortably used regardless of whether the autonomous vehicle is traveling in a first or opposite travel direction. The interior assembly maintains a fixed orientation once installed and is not repositioned or rotated within the vehicle when the vehicle's direction of travel changes.

In one aspect, the invention provides a modular autonomous vehicle interior assembly that defines multiple individual passenger privacy pods. The interior assembly may be assembled from modular components for installation within various types of autonomous vehicles and includes partitions, seating, environmental controls, and pod-specific features for privacy and comfort. In certain implementations, the autonomous vehicle may be configured for bi-directional motion, enabling curbside boarding and egress regardless of travel direction. The modular interior assembly remains fixed in orientation once installed and is usable in both uni-directional and bi-directional vehicles while preserving passenger privacy and comfort.

According to another implementation of the present disclosure, there is provided an autonomous vehicle comprising a vehicle body defining an interior space and the interior assembly, wherein the interior assembly is positioned within the interior space.

According to yet another implementation of the present disclosure, there is provided a method of providing a modular interior environment in an autonomous vehicle. The method comprises assembling and installing the modular interior assembly of claim 1 from modular components within a base of an autonomous vehicle, and operating, through a control screen, mobile application, physical switch, gesture interface, or any other suitable control mechanism located within or associated with a passenger privacy pod, one or more of: moving a privacy window pane between open and closed positions, adjusting a reclining passenger seat, deploying or retracting a tray, or locking or unlocking a corresponding luggage compartment.

The present invention is directed to a modular interior assembly having multiple, independent passenger privacy pods for use in autonomous vehicles. The modular interior assembly includes a longitudinal first partition and second, third and fourth partitions fixedly secured transversely to the first partition. Spaces between the partitions define the passenger privacy pods. The modular interior assembly includes passenger seats in each of the passenger privacy pods and privacy windows in the longitudinal first partition between adjacent passenger privacy pods. Each passenger privacy pod may further include a reclining seat and utility tray. Each passenger privacy pod may include independent lighting system, heating, ventilation and air conditioning system and a control screen to control the related systems. Storage compartments are provided on the interior assembly for each of the passenger privacy pods. As used herein, the term “comprising” can also encompass the terms “consisting essentially of” and “consisting of”.

In a first implementation of the invention, a modular interior assembly for use in an autonomous vehicle is provided, the interior assembly comprising:
a longitudinally extending first partition;
a second partition affixed transversely to said first partition and having a first section and a second section;
a third partition affixed transversely to said first partition and having a first section and a second section;
a fourth partition affixed transversely to said first partition and having a first section and a second section
a floor supporting said first partition, said second partition and said third partition; and
a privacy window positioned in said first partition including a window pane movable between a first or deployed condition and a second or retracted condition, wherein said first partition, said first section of said second partition and said first section of said third partition define a first passenger privacy pod and said first partition, said first section of said second partition and said first section of said fourth partition define a second privacy pod.

In a second aspect, the first partition, the second section of the second partition and the second section of the third partition may define a third passenger privacy pod.

In another aspect, the first partition, the second section of the second partition and the second section of the fourth partition may define a fourth passenger privacy pod.

In another aspect, the first passenger privacy pod may include a first reclining passenger seat.

In another aspect, the first passenger privacy pod may include a retractable tray.

In another aspect, the first passenger privacy pod may include a lighting assembly.

In another aspect, the first passenger privacy pod may include an HVAC system.

In another aspect, the first passenger privacy pod may include a control screen.

In a second implementation of the invention, a modular interior assembly for use in an autonomous vehicle is provided, the interior assembly comprising:
a longitudinally extending first partition, said first partition having a first section and a second section;
a second partition affixed transversely to said first partition and having a first section and a second section;
a third partition affixed transversely to said first partition and having a first section and a second section;
a fourth partition affixed transversely to said first partition and having a first section and a second section
a floor supporting said first partition, said second partition and said third partition;
a first privacy window positioned in said first section of said first partition including a window pane movable between a first or deployed condition and a second or retracted condition;
a second privacy window positioned in said second section of said first partition, wherein said first section of said first partition, said first section of said second partition and said first section of said third partition define a first passenger privacy pod and said second section of said first partition, said first section of said second partition and said first section of said fourth partition define a second privacy pod.

In a second aspect, the first section of the first partition, the second section of the second partition and the second section of the third partition may define a third passenger privacy pod.

In another aspect, the second section of the first partition, the second section of the second partition and the second section of the fourth partition may define a fourth passenger privacy pod.

In another aspect, the first privacy pod may include a first reclining passenger seat.

In another aspect, the first passenger privacy pod may include a control screen, the control screen being operable to move the first privacy window between the deployed and retracted conditions.

In another aspect, the first passenger privacy pod may include a lighting assembly.

In another aspect, the first passenger privacy pod may include an HVAC assembly.

In another aspect, the first passenger privacy pod may include a retractable tray.

In another aspect, the interior assembly may further include a first compartment associated with the first passenger privacy pod.

In another aspect, the interior assembly may further include a second compartment associated with the second passenger privacy pod.

In a third implementation of the invention, a modular interior assembly for use in a two person autonomous vehicle comprises A modular interior assembly for use in an autonomous vehicle, the interior assembly comprising:
a longitudinally extending first partition;
   a second partition affixed transversely to said first partition and having a first section and a second section;
   a third partition affixed transversely to said first partition and having a first section and a second section;
   a floor supporting said first partition, said second partition and said third partition; and
   a privacy window positioned in said first partition including a window pane movable between a first or deployed condition and a second or retracted condition, wherein said first partition, said first section of said second partition and said first section of said third partition define a first passenger privacy pod and said first partition, said second section of said second partition and said second section of said third partition define a second privacy pod.

In a second aspect, said first passenger privacy pod may include a reclining passenger seat.

In another aspect, said first passenger privacy pod may include a control screen operating the privacy window.

In certain implementations, the autonomous vehicle may be configured for bi-directional motion, thereby enabling curbside boarding and egress for all pods irrespective of pod placement.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front, left side isometric view, partially shown in phantom, of an autonomous vehicle interior assembly with customizable privacy pods located in a mini-van style autonomous vehicle in accordance with a first illustrative embodiment of the present invention;

FIG. 2 presents a front, left side isometric view of the autonomous vehicle interior assembly with customizable privacy pods illustrated in FIG. 1 with front and rear privacy windows in partially open conditions;

FIG. 3 presents rear, left side isometric view, partially shown in phantom, of the autonomous vehicle interior assembly with customizable privacy pods located in an autonomous vehicle illustrated in FIG. 1 with individualized retractable trays in deployed conditions;

FIG. 4 presents a rear, left side isometric view, partially shown in phantom, of the autonomous vehicle interior assembly with customizable privacy pods illustrated in FIG. 3 with front and rear privacy windows in closed privacy conditions and the individualized retractable trays shown in operation;

FIG. 5 presents a rear, left side isometric view, partially shown in phantom, of the autonomous vehicle interior assembly illustrated in FIG. 3 with rear luggage compartments in open conditions;

FIG. 6 presents a front, left side isometric view of the autonomous vehicle interior assembly with customizable privacy pods similar to FIG. 2 in use with front and rear passengers in reclining seats of the autonomous vehicle interior assembly;

FIG. 7 presents a front, left side isometric view, partially shown in phantom, of the autonomous vehicle interior assembly with customizable privacy pods of FIG. 2 located in a multi-purpose style autonomous vehicle in accordance with a second illustrative use of the present invention; and

FIG. 8 presents a front, left side isometric view, partially shown in phantom, of an alternative embodiment of the autonomous vehicle interior assembly with customizable privacy pods located in a two-seater style autonomous vehicle in accordance with a third illustrative use of the present invention.

Like reference numerals refer to like parts throughout the several views of the drawings.

### DETAILED DESCRIPTION

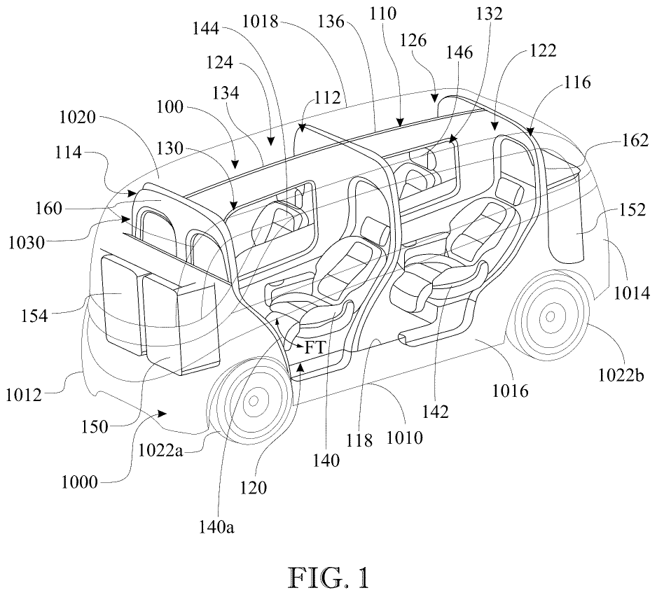

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward an autonomous vehicle interior assembly, having customizable, individual privacy pods to maintain passenger privacy, for use in autonomous vehicles.

Referring to FIGS. 1-5, and initially with regard to FIG. 1, an autonomous vehicle interior assembly having individual privacy pods, hereinafter interior assembly 100, is illustrated in accordance with an exemplary embodiment of the present invention. As shown, the interior assembly 100 is a modular system formed from a set of separately manufactured components—such as a longitudinal partition, horizontal partitions, and associated seating and pod features—that are installed within the interior space of an autonomous vehicle 1000. As used herein, the term “modular” refers to the ability to assemble the interior assembly 100 from multiple modular components within the vehicle body, and does not require the interior to be transferable or installable as a single unit.

In the first disclosed use of the interior assembly 100, the interior assembly 100 is provided for use in a mini-van style autonomous vehicle 1000 having a bottom or base 1010, upon which the interior assembly 100 is positioned. The autonomous vehicle 1000 includes a closed front side 1012, a closed rear side 1014 and closed left and right sides 1016 and 1018, respectively. As used herein with regard to the autonomous vehicle 1000, the term “closed” means devoid of any windows i.e. is solid. The autonomous vehicle 1000 also has a roof 1020. The autonomous vehicle 1000 further includes four wheels 1022 of which two, 1022a and 1022b, are illustrated. Together, the base 1010, closed front side 1012, a closed rear side 1014, closed left and right sides 1016 and 1018 and roof 1020 define an interior space 1030 within which the interior assembly 100 is located. While not specifically shown, doors are incorporated into the right and left sides 1016 and 1018, respectively, for access to the interior space 1030 by passengers.

The interior assembly 100 is provided to allow passengers to travel in individual compartments and in complete privacy. Thus, the interior assembly 100 generally includes longitudinal or first partition 110 and a middle horizontal or second partition 112 transverse to the first partition 110. The interior assembly 100 further includes a front horizontal or third partition 114 transverse to the first partition 110 and a rear horizontal or fourth partition 116 also transverse to the first partition 110. A floor 118 is provided in the interior assembly 100 and supports the first, second, third and fourth partitions 110, 112, 114 and 116, respectively. While not specifically shown, the interior assembly additionally may include a roof located above the first, second, third and fourth partitions 110, 112, 114 and 116. The roof supports the partitions on the top and helps to fully separate the individual privacy pods.

It should be noted that in the construction of the interior assembly 100, the first, second, third and fourth partitions 110, 112, 114 and 116 along with the floor 118 may be formed integrally as a monolithic unit for ease of transfer of the interior assembly 100 between autonomous vehicles 1000 or may be formed separately and secured together for ease of installation in the autonomous vehicles. Further, it should be noted that the second, third and fourth partitions 112, 114 and 116, respectively, are generally solid and devoid of any windows or other openings for viewing out of the interior assembly 100. However, and while not specifically illustrated, in an alternative embodiment, the third and fourth partitions 114 and 116 may include windows allowing passengers to see out the front side 1012 and rear side 1014 of the autonomous vehicle. For example, windows in the front side 1012 would allow passengers to see out a front windshield (not shown) of the autonomous vehicle 1000.

The first partition 110 and the second partition 112 may be fixedly secured together by various means such as, for example welding, gluing, bolt or screwing, etc. Similarly, the third and fourth partitions 114 and 116, respectively, may also be fixedly secured to the first partition 110 by similar means. The first, second, third and fourth partitions 110, 112, 114 and 116, respectively, are also fixedly secured to the floor 118 by similar means. As used herein, the term “fixedly secured” includes the terms “permanently affixed” and “semi-permanently affixed” and is understood to mean that the components are not easily removable from each other.

The first and second partitions 110 and 112, respectively, of the interior assembly 100 define privacy areas or “pods” each configured to accept an individual passenger in privacy and isolation from the other passengers in the autonomous vehicle 1000. Thus, the first and second partitions 110 and 112 define a front left or first passenger privacy pod 120 and a rear left or second passenger privacy pod 122. The first and second passenger privacy pods 120 and 122 are positioned in-line and located along the left side 1016 of the autonomous vehicle 1000.

Likewise, the first and second partitions 110 and 112, of the interior assembly 100, define a front right or third passenger privacy pod 124 and a rear right or fourth passenger privacy pod 126. The third and fourth passenger privacy pods 124 and 126 are positioned in-line and located along the right side 1018 of the autonomous vehicle 1000.

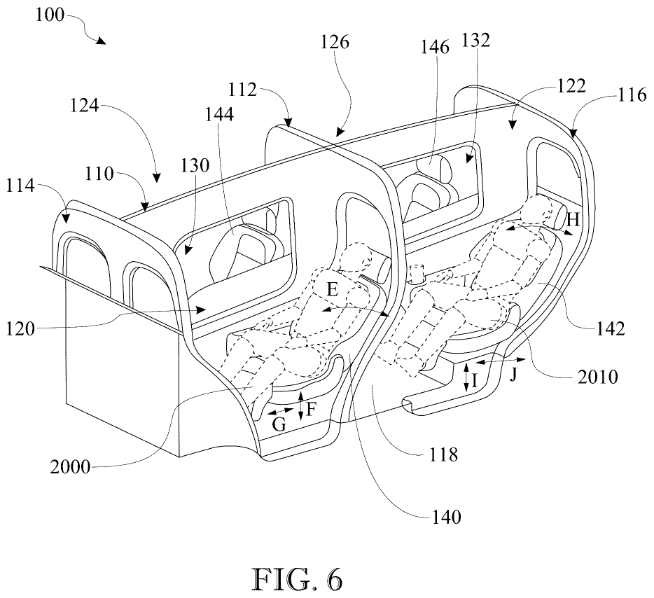

In order to allow the passengers 2000 (see FIG. 6) in adjacent privacy pods to communicate with each other, the interior assembly 100 includes a front or first privacy window 130 provided between the first and third passenger privacy pods 120 and 124, respectively, and a rear or second privacy window 132 provided between the second and fourth passenger privacy pods 122 and 126, respectively. More particularly, the front or first privacy window 130 is positioned in a front or first section 134 of the first partition 110 and the rear or second privacy window 132 is positioned in a rear or second section 136 of the first partition 110. It should be noted that, the first and second privacy windows 130 and 132 are internal to the interior assembly 100 for communication between adjacent pods.

It should be noted that external doors (not shown) provided in the left side 1016 and right side 1018 of the autonomous vehicle may include windows allowing passengers situated in the first, second, third and fourth passenger privacy pods 120, 122, 124 and 126 to see outside the autonomous vehicle 1000. Additionally, should a privacy window be in an open or retracted condition as discussed in detail hereinbelow, a passenger in one privacy pod may see out a door window of an adjacent passenger pod. For example, if the first privacy window 130 is in an open condition and door windows of doors associated with the first privacy pod 120 is also open, a passenger in the third privacy pod 124 may look through the first privacy window 130 and see out the open door window associated with the first privacy pod 120.

The first privacy window 130 allows passengers in the first and third passenger privacy pods 120 and 124, respectively, to selectively communicate with each other in a manner described in more detail hereinbelow. Similarly, the second privacy window 132 allows the passengers in the second and fourth passenger privacy pods 122 and 126, respectively, to selectively communicate with each other.

Seats are provided in the interior assembly 100 to carry the passengers. Thus, the first passenger privacy pod 120 includes a front left or first passenger seat 140 and the second passenger privacy pod 122 includes rear left or second passenger seat 142. Likewise, the third passenger privacy pod 124 includes a front right or third passenger seat 144 and the fourth passenger privacy pod 116 includes a rear right or fourth passenger seat 146. The first, second, third and fourth passenger seats 140, 142, 144 and 146, respectively, are reclining type seats for the comfort and convenience of passengers such as, for example passengers 2000 (See FIG. 6) and are secured to the floor 118 of the interior assembly 100.

The autonomous vehicle interior assembly 100 may further be provided with individualized storage areas for each of the privacy pods. For example, the interior assembly 100 may be provided with a front left or first luggage or storage compartment 150 accessible only by a passenger in the first passenger privacy pod 120. Similarly, the interior assembly 100 may be provided with a rear left second luggage or storage compartment 152 accessible only by a passenger in the second passenger privacy pod 122.

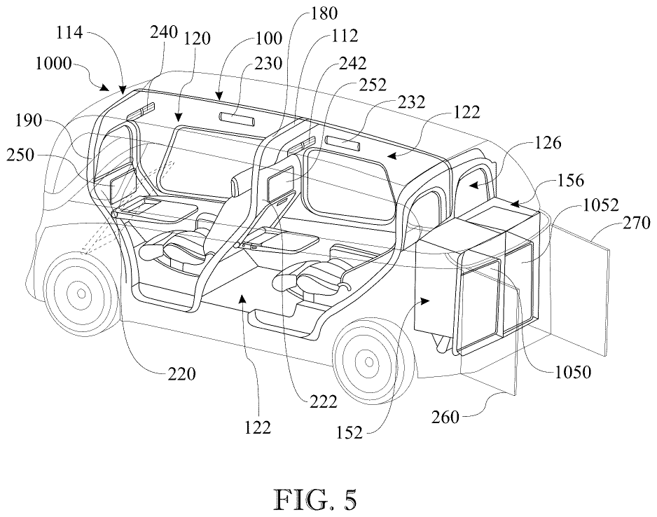

Likewise, the interior assembly may also include a front right or third luggage or storage compartment 154 accessible only by a passenger in the third passenger privacy pod 124 and a rear right or fourth luggage or storage compartment 156 (See FIG. 5) accessible only by a passenger in the fourth passenger privacy pod 126. As shown, the first and second storage compartments 150 and 154, respectively, are positioned on a front face 160 of the front horizontal or third partition 114 while the third and fourth storage compartments 152 and 156 are positioned on a rear face 162 of the rear horizontal or fourth partition 116. The first, second, third and fourth storage compartments 150, 152, 154 and 156 are accessible from outside the autonomous vehicle 1000 in a manner described in more detail hereinbelow.

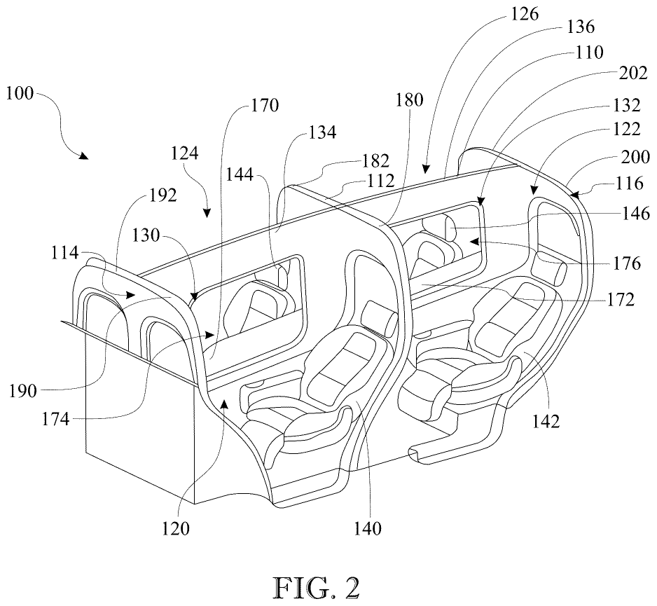

Turning now to FIG. 2, the front or first privacy window 130 includes a first window pane 170 and the rear or second privacy window 132 includes a second window pane 172. More specifically, the front or first window pane 170 is movably mounted in a front or first window opening 174 defined in the front section 134 of the first partition 110. The first window pane 170 is movable between an open position or retracted condition (FIG. 2) allowing the passengers in the first and third passenger privacy pods 120 and 124, respectively, to communicate with each other and a fully closed or deployed condition to maintain passenger privacy. The first window pane 170 is formed from an opaque material and can be moved up and down by a combination of electric motors (not shown) or other mechanical interfaces. The operation of the first window pane 170 may be computer controlled by on board computer software or controlled manually.

While not specifically shown, the first window pane 170 may be controlled from both the first and third passenger privacy pods 120 and 124 such that a passenger may block operation or set the window to a “privacy mode” preventing a communicative passenger in one of the pods from lowering the first window pane 170 should a non-communicative passenger in the other of the pods not wish to communicate with a passenger in the other pod. The first window pane 170 is sandwiched within the first section 134 of the first partition 110 of the interior assembly 100. Thus, the first section 134 of the first partition 110 may be formed from two or more layers of material (not shown).

Similarly, the rear or second privacy window 132 includes the second window pane 172 and the second section 136 of the first partition 110 defines a rear or second opening 176. The second window pane 172 is mounted for movement within the second opening 176 in a manner similar to that of the first window pane 170. Further, like the first window pane 170, the second window pane 172 is opaque and selectively movable within the second opening 176 by the passengers between open conditions permitting communication between the passengers and a deployed or closed condition preventing communication between the passengers and maintaining privacy. The second section 136 of the first partition 110 may also be formed from two or more layers of material sandwiching the second window pane 172 therebetween.

It should be noted that, similar to the first partition 110 of the interior assembly 100, the second partition 112 may include a left side or first section 180 and a right side or second section 182. Likewise, the front or third partition of the interior assembly may also include a left side or first section 190 and a right side or second section 192. Similarly, the rear or fourth partition 116 may include a left side or first section 200 and a right side or second section 202.

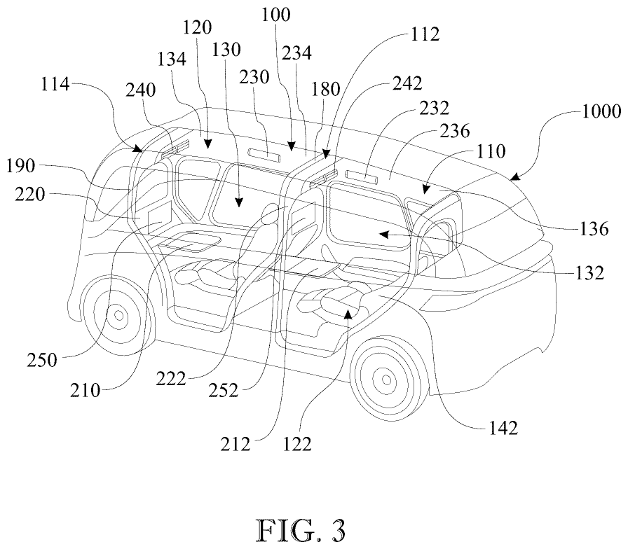

Referring now to FIG. 3, the interior assembly 100 includes a number of convenience and comfort features for the passengers. For example, as shown, movable utility or work stations or retractable trays, such as, for example a front left or first retractable tray 210 and a rear left or second retractable tray 212 may be provided in the first and second passenger privacy pods 120 and 122, respectively. The first and second retractable trays 210 and 212 provide spaces for passengers to work, eat, read, write, etc, and are deployable and retractable for storage out of the way when not in use. While not specifically shown, the third and fourth passenger privacy pods 124 and 126, respectively, are similarly provided with retractable trays.

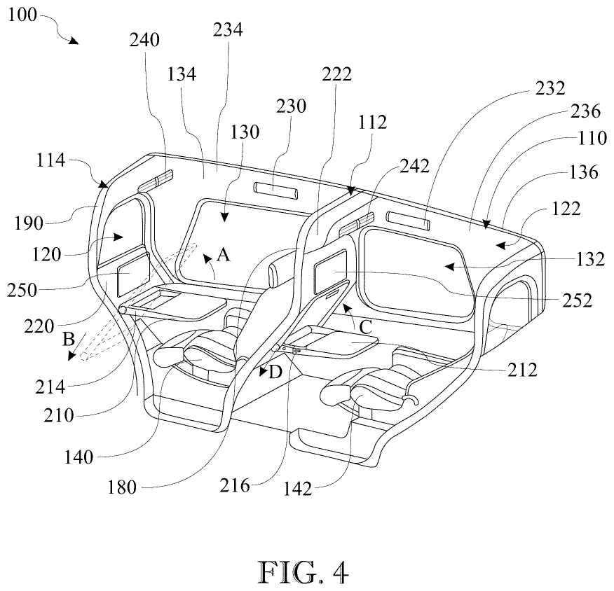

As best shown in FIG. 4, the first retractable tray 210 in the first passenger privacy pod 120 includes a first pivotal bracket 214 operatively associated with the first retractable tray 210 and the third partition 114 such that the first retractable tray 210 may be pivoted up in the direction of arrow “A” and slide downwardly in the direction of arrow “B” to store the first retractable tray 210 within the third partition 114.

Similarly, the second retractable tray 212 in the second passenger privacy pod 122 includes a second pivotal bracket 216 operatively associated with the second retractable tray 212 and the second partition 112. The second retractable tray 212 may be pivoted up in the direction of arrow “C” and slid downwardly in the direction of arrow “D” to store the second retractable tray 212 in the second partition 112.

More specifically, the first retractable tray 210 and first pivotal bracket 214 are movably mounted with regard to a rear or second face 220 of the first section 190 of the front partition 114 of the interior assembly 100. Similarly, the second retractable tray 212 and second pivotal bracket 216 are movably mounted with regard to a rear or second face 222 of the first section 180 of the second partition 112. Thus, the first and second retractable trays 210 and 212, respectively, are movable between a deployed condition in position for use by passengers and a retracted condition wherein the first and second retractable trays 210 and 212 are stored out of the way in the third and second partitions 114 and 112, respectively, of the interior assembly 100.

With continued reference to FIGS. 3 and 4, additional comfort and convenience features such as, for example, lighting and heating/air conditioning/ventilation features are incorporated into the interior assembly 100. The additional comfort and convenience features are specific and individualized to each of the passenger privacy pods such that each passenger may control the comfort level in the particular passenger privacy pod they occupy independent of the other passenger privacy pods. While the following description is given with regard to the first and second passenger privacy pods 120 and 122, respectively, the additional comfort and convenience features are also present in the third passenger privacy pod 124 and fourth passenger privacy pod 126.

For example, the interior assembly 100 includes front left or first lighting assembly 230 for illuminating the first passenger privacy pod 120 and a rear left or second lighting assembly 232 for illuminating the second passenger privacy pod 122. The first lighting assembly 230 is provided in a first face 234 of the first section 134 of the first partition 110 of the interior assembly 100 for illuminating the first passenger privacy pod 120. The first lighting assembly 230 may be individually controlled by a passenger using controls, as discussed in more detail hereinbelow, in the first passenger privacy pod 120 or may be controlled by an onboard or off site computer system (not shown).

Likewise, the second lighting assembly 232 is provided in a first face 236 of the second section 136 of the first partition 110. The second lighting assembly 232 is provided to illuminate the second passenger privacy pod 122 for the convenience of a passenger in the second passenger privacy pod 122 and may be controlled by the passenger or computer.

Additionally, the interior assembly 100 includes a front left or first ventilation assembly 240 for providing heat, air condition or ventilation of outside air to the first passenger privacy pod 120 and a rear left or second ventilation system 242 for providing heat, air conditioning or ventilation of outside air to the second passenger privacy pod 122. While not specifically shown, the first and second ventilation assemblies 240 and 242 include needed heating mechanism, cooling mechanism and ventilation fans of the type commonly used in vehicles and located in the interior assembly 100. Alternatively, the interior assembly 100 can be configured to use the heating, cooling and ventilation mechanisms provided in the subject autonomous vehicles and channel them into the disclosed passenger privacy pods through the ventilation assemblies of the interior assembly 100.

More specifically, as shown, the first ventilation assembly 240 is preferably located in the rear face 220 of the first section 190 of the third partition 114 to provide ventilation to a passenger in the first passenger privacy pod 120. Likewise, the second ventilation assembly 242 is preferably located in the rear face 222 of the first section 180 of the second partition 112 to provide ventilation to a passenger in the second passenger privacy pod 122. Additional heating, ventilation and air conditioning assemblies or “HVAC” systems (not show) are similarly situated to provide ventilation to the third and fourth passenger privacy pods 124 and 126, respectively.

With reference now to FIGS. 3-5, control assemblies or control screens, such as, for example a front left or first video or control screen 250 and a rear left or second video or control screen 252 may be provided to allow each passenger to individually control the various features associated with the respective first and second passenger privacy pods 120 and 122. The first control screen 250 may provide entertainment video, computer or internet access and may include controls for operating the front privacy window 130, the first lighting assembly 230 and/or the first ventilation system 240. Preferably, as shown, the first control screen 250 is located in the rear face 220 of the first section 190 of the third partition 114 of the interior assembly 100 for use by a passenger in the first passenger privacy pod 120.

Similarly, the second control screen 252 may provide entertainment video, computer or internet access and may include controls for operating the second privacy window 132, the second lighting assembly 232 and the second ventilation system 242. Preferably, the second control screen 252 is located in the rear face 222 of the first section 180 of the second partition 112 of the interior assembly 100 for use by a passenger in the second passenger privacy pod 122. The first and second control screens 250 and 252, respectively, may also provide controls for features associated with the first and second reclining passenger seats 140 and 142 described in more detail hereinbelow with respect to FIG. 6.

Still further, the first and second control screens 250 and 252 of the interior assembly 100 may provide functions for allowing passengers to enter desired destinations of travel as well as pay for the transportation provided by the autonomous vehicle 100. It should be noted that, the third and fourth passenger privacy pods 124 and 126, respectively, of the interior assembly 100 include similar control screens (not shown) to allow passengers in the third and fourth passenger privacy pods 124 and 126 to perform similar functions.

Turning now specifically to FIG. 5, and as noted hereinabove, each passenger privacy pod is provided with an individual storage locker or luggage compartment accessible only by the passenger occupying the subject passenger privacy pod. While the following discussion is given with regard to the second luggage compartment 152 associated with the second passenger privacy pod 122 and the fourth luggage compartment 156 associated with the fourth passenger privacy pod 126, the first luggage compartment 150 (FIG. 1) associated with the first passenger privacy pod 120 and the third luggage compartment 154 (FIG. 1) associated with the third passenger privacy pod 124 function identically.

As shown, the second luggage compartment 152 is provided to retain luggage, packages or other items of a passenger in the second passenger privacy pod 122. For example, a piece of luggage 1050 may be contained within the second luggage compartment 152 during transportation. A second luggage compartment door 260 is movably mounted to the second luggage compartment 152 to secure the piece of luggage within the second luggage compartment 152. As noted hereinabove, each luggage compartment of the interior assembly is associated with a specific and corresponding passenger privacy pod and can only be accessed by a passenger in the associated passenger privacy pod. Thus, for example, the second luggage compartment door 260 of the second luggage compartment 152 can only be operated by a passenger in the second passenger privacy compartment 122. The second luggage compartment door 260 may be locked, unlocked and operable by a mechanical or electronic key associated with the second luggage compartment 152 or by use of the second control screen 252 in the second passenger privacy pod 122.

Likewise, the fourth luggage compartment 156 of the interior assembly 100 also has a fourth luggage compartment door 270 to secure items, such as, for example luggage 1052, within the fourth luggage compartment 156. The fourth luggage compartment 156 is associated with the fourth passenger privacy pod 126 and the fourth luggage compartment door 270 is only accessible to by a passenger occupying the fourth passenger privacy pod 126 in a manned identical to that described above, with regard to the second passenger compartment 120.

Referring now to FIG. 6, and as noted hereinabove, the first, second, third and fourth passenger privacy pods 120, 122, 124 and 126 are provided with respective first, second, third and fourth reclining passenger seats 140, 142, 144 and 146. While the following discussion is given with regard to the first and second passenger reclining seats 140 and 142, respectively, the description of operation is equally applicable to the third and fourth passenger reclining seats 144 and 146.

A passenger, such as, for example a first passenger 2000 seated in the first passenger reclining seat 140 in the first passenger privacy pod 120 of the interior assembly 100 can recline the first passenger reclining seat 140 in the direction of arrow “E”. Additionally, the first passenger 2000 may also move the first passenger reclining seat 140 up and down in the direction of arrow “F” and forward and back in the direction of arrow “G”. The first passenger seat reclining seat 140 may also include a thigh support 140a (see FIG. 1) which can be moved in the direction of arrow “FT”. The thigh support 140a may be controlled manually or through the use of the front control screen 250 (FIG. 5), through controls on the first passenger reclining seat 140 or manually. The remaining second, third and fourth reclining passenger seats 142, 144 and 146, respectively, may include similar movable thigh supports controlled in like manner.

The first passenger reclining seat 140 may be moved manually or may have associated motors (now shown) and be controlled through the first control screen 250 (FIG. 5) or through separate controls on the first passenger reclining seat 140. Still further, the first passenger reclining seat 140 may be provided with additional conveniences such as, for example, heat, cooling, vibration and message, audio etc, which may be controlled through the first control screen 250 (FIG. 5) or in the first passenger reclining seat 140.

Likewise, a second passenger 2010 seated in the second passenger reclining seat 142 may recline the second passenger reclining seat 142 in the direction of arrow “H” and move the second passenger reclining seat 142 up and down and forward and back in the directions of arrows “I” and “J”, respectively. Controls on the second passenger reclining seat 142 may be used in a similar manner to that described hereinabove to operate the second passenger reclining seat 142 or may be controlled through the second control screen 252 (FIG. 5). Other functions such as heat, cooling, vibration and massage, audio may also be associated with the second passenger reclining seat 142.

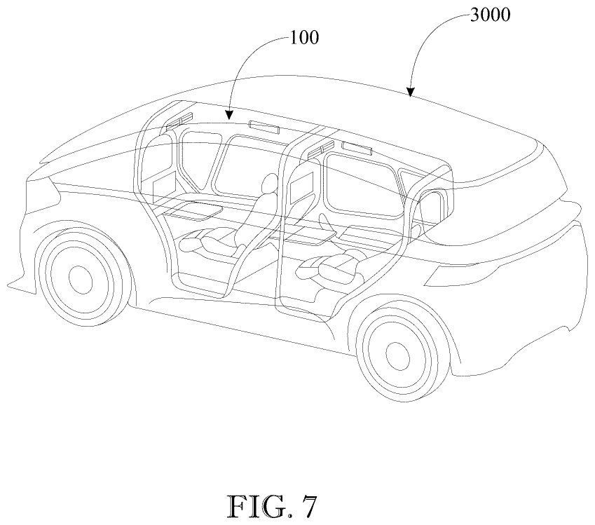

Referring to FIG. 7, and as noted hereinabove, the interior assembly 100 is a modular unit that can be installed in a variety of vehicles and, more particularly, autonomous vehicles. As shown, in contrast to the mini-van style autonomous vehicle 1000 (FIG. 1) described hereinabove, the interior assembly 100 can be installed in a sport utility or multi-purpose autonomous vehicle 3000. All the functions of the interior assembly 100 described herein above are available and operable within the multi-purpose autonomous vehicle 3000.

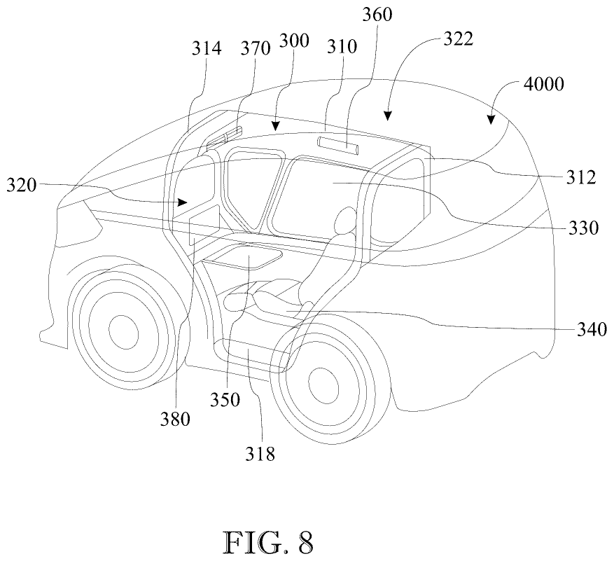

Turning now to FIG. 8, there is illustrated a two person or passenger privacy pod interior assembly 300 for use in a two person vehicle such as, for example, two person autonomous vehicle 4000. Similar to the interior assembly 100 described hereinabove, the interior assembly 300 includes a longitudinal or first partition 310, a horizontal or second partition 312 and a horizontal or third partition 314. The interior assembly also include a floor 318. The interior assembly 300 defines a left side or first passenger privacy pod 320 and a right side or second passenger privacy pod 322.

Although the embodiments shown and described herein depict a forward-oriented vehicle configuration for ease of illustration, alternative embodiments may be operable in either travel direction, such that the sides described as the “front” and “rear” are interchangeable when the vehicle direction is reversed. In bi-directional embodiments, reversing the vehicle changes which side of the vehicle faces the curb. Accordingly, either the left-side doors or the right-side doors may provide curbside boarding and egress, depending on roadway orientation and vehicle travel direction. This approach enables the autonomous vehicle to maintain curbside compliance in both orientations while utilizing the same fixed modular interior assembly. Importantly, no rotation, reconfiguration, or repositioning of the interior partitions or passenger privacy pods is required; only the vehicle's direction of travel changes.

The following discussion is given with regard to the first passenger privacy pod 320 of the interior assembly 300 but is equally applicable to the second passenger privacy pod 322 of the interior assembly 300. Similar to the interior assembly 100 described hereinabove, the interior assembly 300 includes a privacy window 330 in the first partition 310 to allow for communication between passengers (not shown) in the first and second passenger privacy pods 320 and 322. The first passenger privacy pod 320 includes a first reclining passenger seat 340 movably mounted to the floor 318 and a first retractable tray 350 movably mounted in the third partition 314. A lighting system 360 is mounted in the first partition 310 and HVAC systems 370 and a control screen 380 are mounted in the third partition 314. The privacy window 330 along with the first reclining passenger seat 340, first retractable tray 350, lighting system 360, HVAC systems 370 and the control screen 380 all operated identically to those similar systems described hereinabove.

The foregoing clarification applies throughout the specification and drawings. References to “front,” “rear,” “left,” or “right” are relative designations that may change depending on the direction of vehicle travel and curbside orientation, and are not intended to limit the structure to a particular orientation. The interior assembly itself remains fixed in position once installed, and its partitions, seats, and passenger privacy pods do not rotate or otherwise change orientation when the vehicle changes its direction of travel.

While not specifically illustrated, the interior assembly 300 additionally includes first and second luggage compartments which function identical to those described hereinabove. It should be noted that the interior assembly 300 is also a modular assembly that can find application in a wide variety of two person vehicles, particularly two person autonomous vehicles. Further, the structure of the disclosed privacy pods may also find individual use in single person vehicles such as, for example a single person autonomous vehicle.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An interior assembly configured for installation from modular components within an autonomous vehicle, the interior assembly comprising:
a floor;
a first partition extending in a front-to-rear direction of the autonomous vehicle;
a second partition, a third partition, and a fourth partition, each transverse to the first partition and supported by the floor or a roof, wherein the first, second, third, and fourth partitions together define a plurality of individual passenger privacy pods, each configured to receive an individual passenger in privacy and isolation from adjacent pods;
at least one privacy window positioned in the first partition, each privacy window comprising a window opening and an opaque window pane movably mounted within the window opening between an open position permitting communication between adjacent pods and a closed position providing privacy; and
a plurality of passenger seats, each disposed within a corresponding passenger privacy pod and secured to the floor.

2. The interior assembly of claim 1, wherein the first, second, third, and fourth partitions and the floor are formed either integrally or as separately manufactured components to facilitate installation or manufacturing convenience.

3. The interior assembly of claim 1, wherein the first, second, third, and fourth partitions are separately formed and fixedly secured together for installation in the autonomous vehicle, and wherein one or more of the partitions including the first partition extending in the front-to-rear direction and at least one of the second, third, or fourth transverse partitions are formed as a single piece or as two or more joined sections that collectively define the corresponding partition.

4. The interior assembly of claim 1, wherein the first partition comprises a first section and a second section, and wherein a front privacy window is provided in the first section and a rear privacy window is provided in the second section.

5. The interior assembly of claim 4, wherein the opaque window pane is selectively movable by an electric motor or an actuator and is operable through a control interface accessible to occupants of the associated passenger privacy pods, including a control screen, a mobile application, a physical switch, or a user interface.

6. The interior assembly of claim 5, wherein a privacy control feature is configured to restrict opening of the opaque window pane unless the occupants of the associated passenger privacy pods are members of a common party or are otherwise authorized for inter-pod communication.

7. The interior assembly of claim 1, wherein at least one of the passenger privacy pods includes a retractable tray movable between a stored position and a deployed position, the retractable tray being supportable by a pivotal bracket, seat-mounted mechanism, or a suitable support structure.

8. The interior assembly of claim 1, further comprising individualized lighting assemblies and ventilation assemblies, each located and operable within a corresponding passenger privacy pod.

9. The interior assembly of claim 8, wherein each lighting assembly is individually controllable by a passenger through a control screen, a physical switch, or a suitable interface, and wherein each ventilation assembly is configured to deliver heating, cooling, or ventilation airflow to a corresponding passenger privacy pod from any suitable location within the pod.

10. The interior assembly of claim 1, wherein an individual luggage compartment accessible is assigned to each passenger privacy pod, each luggage compartment being positioned outside the corresponding pod and being accessible only by the passenger occupying the corresponding pod.

11. The interior assembly of claim 10, wherein each luggage compartment comprises a lockable compartment door that is unlockable via a mechanical key, an electronic key, a pod-mounted control screen, or a suitable wired or wireless access control system.

12. The interior assembly of claim 1, wherein at least one passenger privacy pod includes a passenger seat configured to provide one or more adjustable seating features, including recline, vertical adjustment, longitudinal adjustment, or thigh support.

13. The interior assembly of claim 1, wherein a passenger interface within each privacy pod is configured to provide one or more features, including entertainment video, internet access, or control of at least one of a privacy window, lighting assembly, ventilation assembly, or seat adjustment.

14. The interior assembly of claim 13, wherein the control screen further enables passengers to enter destinations of travel and perform payment for transportation provided by the autonomous vehicle.

15. The interior assembly of claim 1, wherein the interior assembly is configured for installation in multiple autonomous vehicle types, including at least mini-van-style vehicles and multi-purpose autonomous vehicles.

16. The interior assembly of claim 1, wherein the interior assembly is configurable as a two-person version that comprises the first partition, the second partition, and the third partition defining a left-side passenger privacy pod and a right-side passenger privacy pod.

17. The interior assembly of claim 1, wherein the autonomous vehicle in which the interior assembly is installed is configured for uni-directional and bi-directional travel, wherein the autonomous vehicle is operable in either travel direction with interchangeable front and rear sides, and wherein the autonomous vehicle is further configured to facilitate curbside boarding, egress, and emergency exit from any passenger privacy pod.

18. The interior assembly of claim 1, wherein the interior assembly is configured for use in vehicles operable in either travel direction, without requiring repositioning of the interior assembly, and is oriented to provide consistent passenger privacy and pod functionality regardless of vehicle drive direction.

19. An autonomous vehicle comprising:
a vehicle body defining an interior space; and
the interior assembly of claim 1, wherein the interior assembly is positioned within the interior space.

20. A method of providing a modular interior environment in an autonomous vehicle, the method comprising:
installing the interior assembly of claim 1 as a set of modular components within an interior space of the autonomous vehicle; and
operating, through a passenger interface located within a passenger privacy pod, one or more pod-specific features selected from: moving a privacy window pane between open and closed positions, adjusting a passenger seat, deploying or retracting a tray, or locking or unlocking a corresponding luggage compartment.
